(19) United States
(12) Patent Application Publication
(10) Pub. No.: US 2025/0086932 A1
(43) Pub. Date: Mar. 13, 2025

(54) RECOGNITION SYSTEM AND RECOGNITION METHOD

(71) Applicant: Samsung Electronics Co., Ltd., Suwon-si (KR)

(72) Inventors: Jingbiao NAN, Xi'an (CN); Yohan KIM, Xi'an (CN); Yi GUO, Xi'an (CN)

(73) Assignee: Samsung Electronics Co., Ltd., Suwon-si (KR)

(21) Appl. No.: 18/470,782

(22) Filed: Sep. 20, 2023

(30) Foreign Application Priority Data
Sep. 7, 2023 (CN) 202311153118.3

(51) Int. Cl. G06V 10/75; G06T 7/60; G06T 7/73; G06V 10/77

(52) U.S. Cl. CPC G06V 10/751; G06T 7/60; G06T 7/74; G06V 10/7715; G06T 2207/20221

(57) ABSTRACT

A recognition system and a recognition method are provided. The recognition system includes: an image acquisition module configured to acquire an original image of a target object; an information acquisition module configured to acquire positioning information of the target object; and an image recognition module configured to extract a target region in the original image, and to recognize the target object based on the extracted target region.

### CROSS-REFERENCE TO RELATED APPLICATION

This application claims priority under 35 U.S.C. § 119 to Chinese Patent Application No. 202311153118.3, filed on Sep. 7, 2023, the entire contents of which are incorporated herein by reference.

### TECHNICAL FIELD

The present application relates to a field of image processing and, specifically, to a recognition system and a recognition method.

### BACKGROUND

At present, target detection systems mainly use traditional image processing algorithms (such as a background subtraction method, an optical flow method and a neural network method) to recognize a target object.

In image recognition the detection accuracy of a deep learning neural network is affected by the size of the target object and the image. For example, if a down-sampling rate of the image is too low, it is difficult to ensure the running efficiency of the neural network. On the other hand, if the down-sampling rate of the image is too high, the features of the target object may be lost, thereby affecting the recognition accuracy. For the object with a small size, available features thereof are limited, and their semantic information appears in the shallower feature map. With the deepening of the neural network, detailed information of the small object may disappear completely.

In order to improve the target detection accuracy of the small object, the usual approach is to input an ultra-high resolution image into the neural network, but it leads to a problem that the neural network runs slowly, so how to improve the recognition accuracy of the object with a small size is a problem to be solved.

### SUMMARY

The present disclosure provides a recognition system and a recognition method to solve at least the problems in the above related technologies, or not to solve any of the above problems.

According to a first aspect of the embodiments of the present disclosure, there is provided a recognition system, the recognition system may include processing circuitry configured to acquire an original image of a target object; acquire positioning information of the target object, the positioning information of the target object including information about the target object's position in physical space; extract a target region in the original image based on the positioning information; and recognize the target object based on the extracted target region.

The processing circuitry may further be configured to acquire information about the target object, wherein the recognize the target object includes identifying feature information of the target object based on the extracted target region, and recognizing the target object by comparing the information about the target object with the feature information.

The recognize the target object may include identifying feature information of the target object based on the extracted target region, and recognizing the target object by comparing the feature information with a feature of the target region extracted based on the positioning information.

The feature information may include at least one of a size and a location of the target object in the original image, the feature of the extracted target region comprises at least one of a size and a location of the extracted target region, and the recognize the target object includes comparing at least one of the size and the position of the target object in the original image with the corresponding at least one of the size and the position of the extracted target region.

The extract the target region may include determining, based on the positioning information, a position and a size of the target region in the original image, and extracting the target region based on the position and the size of the target region.

The processing circuitry may be further configured to determine whether there is a plurality of target objects in the original image; extract a plurality of target regions in the original image based on a plurality of positioning information of the plurality of target objects respectively based on a determination that there is the plurality of target objects, the plurality of target regions including at least one corresponding target object of the plurality of target objects, merge adjacent target regions, of the plurality of target regions, into a merged target region, use the merged target region and a remainder of the plurality of target regions as target regions for recognition, and recognize at least one of the plurality of target objects based on the target regions for recognition.

The recognize the at least one of the plurality of target objects may include identifying a plurality of feature information of the plurality of target objects based on the target regions for recognition, and recognizing the at least one of the plurality of target objects by comparing the plurality of feature information with features of the plurality of target regions extracted based on the plurality of positioning information.

According to a second aspect of the embodiments of the present disclosure, there is provided a recognition method, the recognition method may include: acquiring an original image of a target object; acquiring positioning information of the target object, the positioning information of the target object including information about the target object's position in physical space; and extracting a target region in the original image based on the positioning information; and recognizing the target object based on the extracted target region.

The recognition method may further include: acquiring information about the target object, and the recognizing of the target object may include: identifying feature information of the target object based on the extracted target region, and recognizing the target object by comparing the information about the target object with the feature information.

The recognizing of the target object may include: identifying feature information of the target object based on the extracted target region and recognizing the target object by comparing the feature information with a feature of the target region extracted based on the positioning information.

The feature information may include at least one of a size and a location of the target object in the original image, the feature of the extracted target region may include at least one of a size and a location of the extracted target region, and the recognizing of the target object comprises comparing at least one of the size and the position of the target object in the original image with the corresponding at least one of the size and the position of the extracted target region.

The extracting of the target region may include: determining, based on the positioning information, a position and a size of the target region in the original image, and extracting the target region based on the position and the size of the target region.

The recognition method may further include: determining whether there is a plurality of target objects in the original image; extracting a plurality of target regions in the original image, based on a plurality of positioning information of the plurality of target objects respectively based on a determination that there is the plurality of target objects, the plurality of target regions including at least one corresponding target object of the plurality of target objects; merging adjacent target regions of the plurality of target regions into a single target region; using the merged target region and a remainder of the plurality of target regions as target regions for recognition; and recognizing at least one of the plurality of target objects based on the target regions for recognition.

The recognizing of the at least one of the plurality of target objects may include: identifying a plurality of feature information of the plurality of target objects based on the target regions for recognition, and recognizing the at least one of the plurality of target objects by comparing the plurality of feature information with features of the plurality of target regions extracted based on the plurality of positioning information.

According to a third aspect of the embodiments of the present disclosure, there is provided a computer readable storage medium, wherein the computer readable storage medium stores computer program instructions thereon, the computer program instructions, when executed by a processor, cause the processor to perform a recognition method according to the embodiments of the present application.

According to a fourth aspect of the embodiments of the present disclosure, there is provided a system including at least one computing device and at least one storage device storing instructions, wherein the instructions, when executed by the at least one computing device, cause the at least one computing device to perform a recognition method according to the embodiments of the present application.

The recognition system and the recognition method according to the present disclosure obtain the positioning information of the target object by using the location technology, dynamically extract the target region from the original image, and remove the invalid interference object, reduce the image down-sampling rate, so that small object information may appear in the deeper feature map, thus improving the performance of small object recognition.

It should be understood that the above general description and the following detailed description are only illustrative and explanatory, and do not limit the disclosure.

### BRIEF DESCRIPTION

These and other aspects will now be described by way of example with reference to the accompanying drawings, of which:

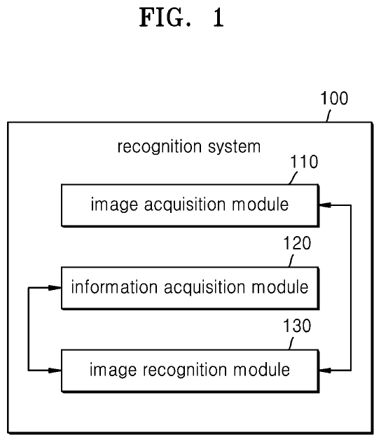

FIG. 1 is a schematic block diagram illustrating a recognition system according to at least one example embodiment;

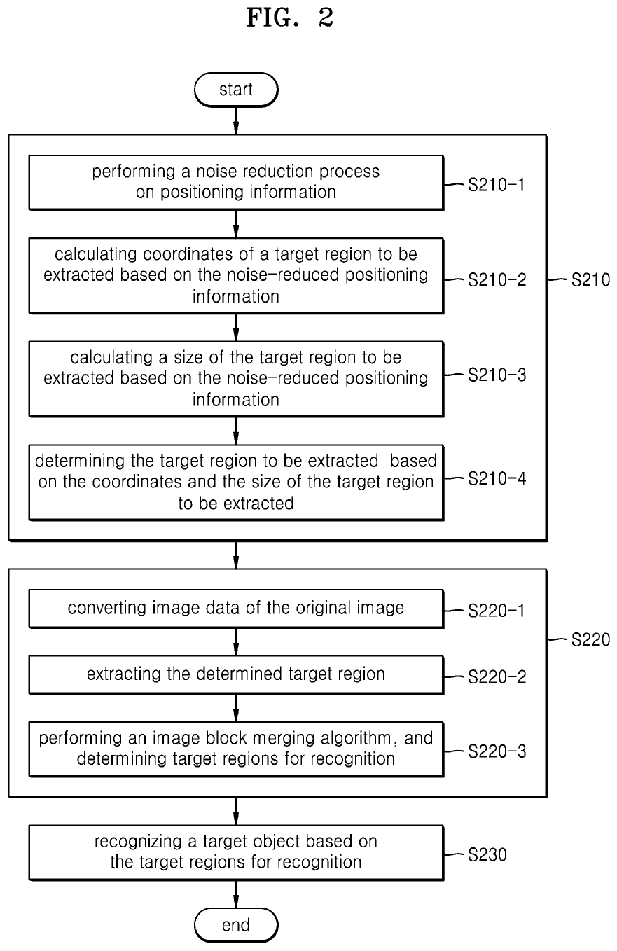

FIG. 2 is an example flowchart illustrating an operation process of an image recognition module according to at least one example embodiment;

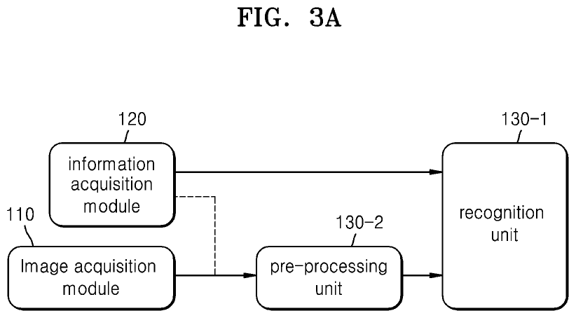

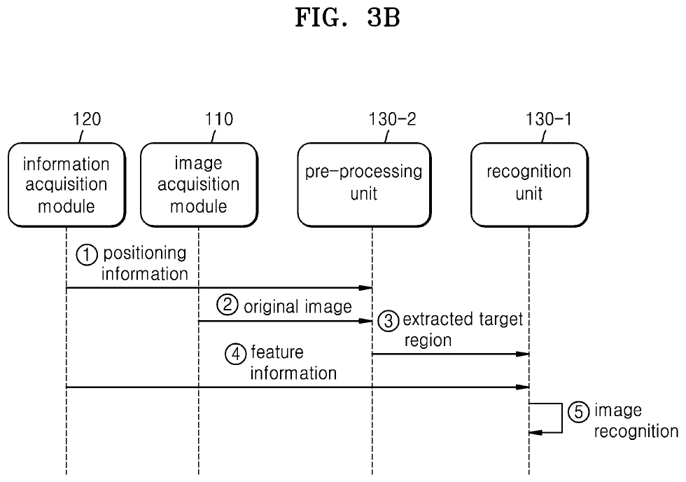

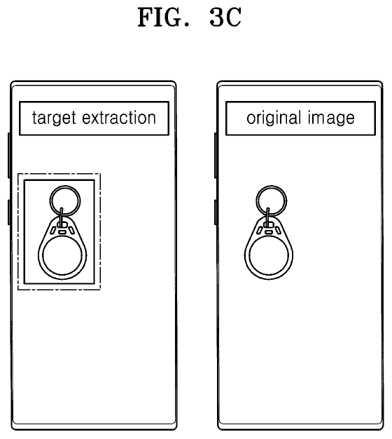

FIGS. 3A to 3C are schematic diagrams illustrating an example of efficient recognition of a target object according to at least one example embodiment;

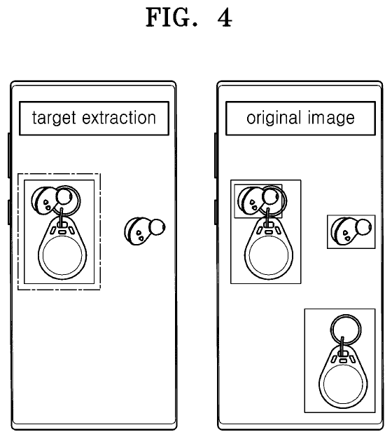

FIG. 4 is a schematic diagram showing an example of accurate recognition of a target object according to at least one example embodiment;

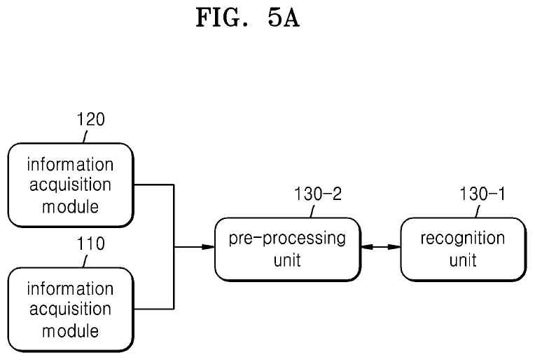

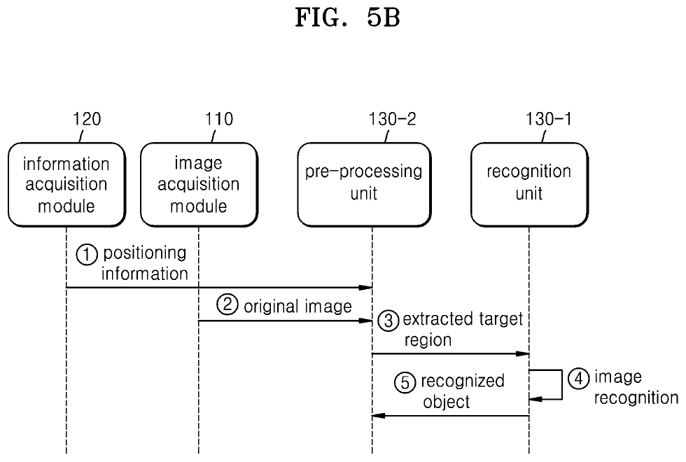

FIGS. 5A to 5C are schematic diagrams illustrating another example of accurate recognition of a target object according to at least one example embodiment;

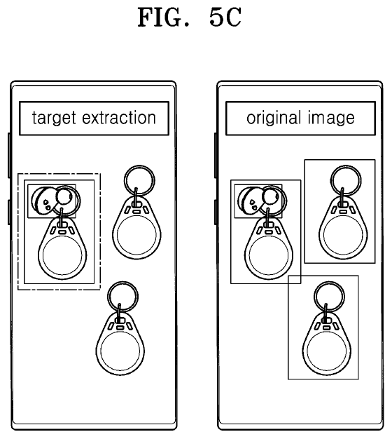

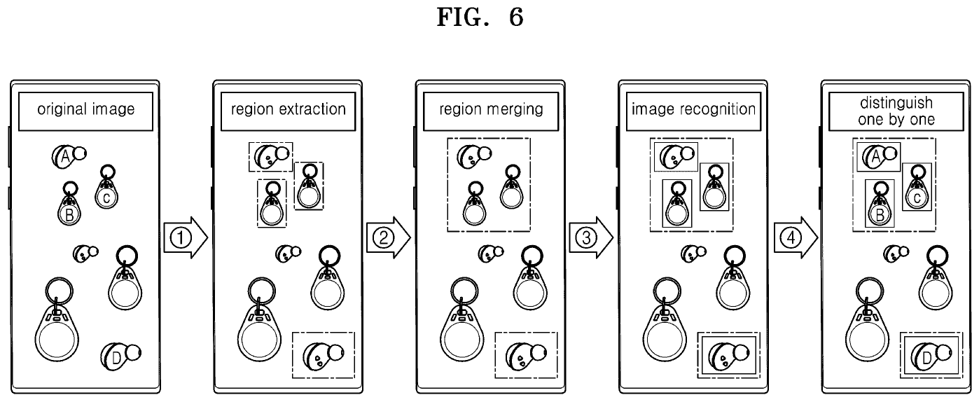

FIG. 6 is a diagram showing an example of accurate recognition of a plurality of target objects according to at least one example embodiment; and

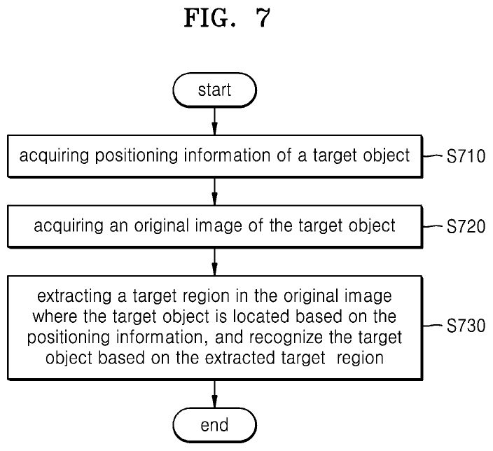

FIG. 7 is a flowchart showing a recognition method according to at least one example embodiment.

### DETAILED DESCRIPTION

In order to make those skilled in the art better understand the technical solutions of the present disclosure, the technical solutions in the embodiments of the present disclosure will be clearly and completely described below with reference to the accompanying drawings.

It should be noted that the numerical terms “first”, “second,” and the like in the description and claims as well as the above drawings of the present disclosure are used to distinguish similar objects and are not necessarily used to describe a specific order or sequence. It should be understood that the data used in this way may be interchanged under appropriate circumstances, so that the embodiments of the present disclosure described herein can be implemented in an order other than those illustrated or described herein. The embodiments described in the following exemplary embodiments are not representative of all embodiments consistent with the present disclosure. Rather, they are only examples of devices and methods consistent with some aspects of the present disclosure as detailed in the appended claims.

It should be noted here that “at least one of several items” in the present disclosure means that these three parallel situations of “any one of the several items”, “any combination of the several items”, and “all of the several items” are included. For example, “including at least one of A and B” includes the following three parallel situations: (1) including A; (2) including B; (3) including A and B. Another example is “to execute at least one of Step 1 and Step 2”, which means the following three parallel situations: (1) execute Step 1; (2) execute Step 2; (3) execute Step 1 and Step 2.

FIG. 1 is a schematic block diagram illustrating a recognition system 100 according to at least one example embodiment.

The recognition system 100 may be installed in various computing apparatuses, smart devices, servers, etc., to enable recognition of a target object (such as an item, a person, etc.). The recognition system 100 may include an image acquisition module 110, an information acquisition module 120, and an image recognition module 130.

The image acquisition module 110 may acquire an original image of the target object. For example, the image acquisition module 110 may acquire image data of the original image of the target object from an image capture device (e.g., a camera, a webcam, etc.) and convert the image data into a type of data that the recognition system 100 may process. In at least one embodiment, the image capture device may be mounted at a particular location, such that a position of a target object can be determined based on the relative position of target object, as discussed in further detail below.

The information acquisition module 120 may acquire positioning information of the target object. For example, the information acquisition module 120 may acquire the positioning information of the target object from a positioning module (not shown) of the recognition system 100. The positioning module may position the target object by using a positioning technology such as Bluetooth technology, ultra-wideband (UWB) technology, wireless fidelity (WiFi) technology, etc., and may be mounted in the same location as the above image capture device and/or may be integrated with the above image capture device. For example, in at least one example, the target object may be (or include) a wireless identification device, such as a radio-frequency identification (RFID) tag, configured to communicate with the positioning module. The positioning information includes data representing the position of the target object in physical space. For example, the positioning information may include a distance (D), an elevation angle (or altitude angle (Elevation)), an azimuth angle (Azimuth), etc. of the target object in relation to, e.g., the positioning technology and/or the image capture device.

In addition, the information acquisition module 120 may also perform noise reduction processing on the positioning information of the target object. For example, the positioning information may be noise-reduced by using a method such as wavelet transform, Vondrak filtering, Kalman filtering, etc.

The image recognition module 130 may extract a target region in the original image where the target object is located based on the positioning information, and recognize the target object based on the extracted target region. For example, the image recognition module 130 may determine a position (e.g., coordinates) and a size of the target region in the original image where the target object is located based on the positioning information, and extract the target region based on the position and the size of the target region, and recognize the target object based on the extracted target region.

For example, the image recognition module 130 may dynamically calculate coordinates of the target region (e.g., coordinates of a center point of the target region (Y, X)) based on the altitude angle (Elevation) and the azimuth angle (Azimuth) in the positioning information by using a dynamic calculation algorithm for target region coordinates as described below:

Vertical coordinate Y=ImgH*(Elevation−ElevationMin)/(ElevationMax−ElevationMin), and

Horizontal coordinate X=ImgW*(Azimuth−AzimuthMin)/(AzimuthMax−AzimuthMin)
where ElevationMax and ElevationMin represent the maximum altitude angle (maximum angle visible in elevation) and the minimum altitude angle (minimum angle visible in elevation) of the image acquisition device respectively, AzimuthMax and AzimuthMin represent the maximum azimuth angle (maximum angle visible in the left view) and minimum azimuth angle (maximum angle visible in the right view) of the image acquisition device respectively, and ImgH and ImgW represent a width and a height of the original image output by the image acquisition device respectively. The ElevationMax, ElevationMin, AzimuthMax, AzimuthMin, ImgH and ImgW are fixed and known, and are determined by the above image acquisition device.

In addition, for example, the image recognition module 130 may dynamically calculate a width (W) and a height (H) of the target region based on the distance (D) in the positioning information by using a dynamic calculation algorithm for a target region size as described below:

$$W = Wo * Wi / ( 2 * D * Math . tan ( AzimuthMax - AzimuthMin ) / 2 ) ) , and$$

$$H = Ho * Hi / ( 2 * D * Math . tan ( ElevationMax - ElevationMin ) / 2 ) )$$

where Wo and Ho may be an actual width and height of the target object respectively, and may be determined by comparison to a known value and/or a user input. Wi and Hi may be the same as the above ImgW and ImgH respectively. Math·tan( ) may indicate taking a tangent value.

Based on the calculated coordinates (Y and X) and size (W and H) of the target region, the target region for each target object may be expressed as:

$$Top = Y - H / 2$$

$$Right = X + W / 2$$

$$Bottom = Y + H / 2$$

$$Left = X - W / 2$$

where Top is the vertical coordinate of the upper boundary of the target region, Right is the horizontal coordinate of the right boundary of the target region, Bottom is the vertical coordinate of the lower boundary of the target region, and Left is the horizontal coordinate of the left boundary of the target region.

In addition, if there is a plurality of target objects in the original image, a plurality of target regions may be identified, and in order to improve recognition performance, a block merging algorithm may be used to merge adjacent target regions of the plurality of target regions into a single target region so that the merged target region and the remaining target regions of the plurality of target regions (e.g., other than the merged target region) are used as target regions for recognition (e.g., as the input source for image recognition).

For example, when a target object A and a target object B are close to each other, the merged target region may be expressed as:

Top=Math·min(TopA,TopB)

Right=Math·max(RightA,RightB)

Bottom=Math·max(BottomA,BottomB)

Left=Math·min(LeftA,LeftB)
where Math·min( ) and Math·max( ) may indicate taking the minimum and maximum values, respectively.

FIG. 2 is an example flowchart illustrating an operation process of the image recognition module 130 according to at least one example embodiment.

First, at step S210, the image recognition module 130 may process the positioning information. For example, at step S210-1, the image recognition module 130 may perform a noise reduction process on the positioning information; at steps S210-2 and S210-3, the image recognition module 130 may calculate coordinates and a size of a target region to be extracted based on the noise-reduced positioning information; and at step S210-4, the image recognition module 130 may determine the target region to be extracted based on the coordinates and the size of the target region to be extracted.

Then, at step S220, the image recognition module 130 may process an original image of the target object. For example, at step S220-1, the image recognition module 130 may convert image data of the original image; at step S220-2, the image recognition module 130 may extract the determined target region; And at step S220-3, if there are target regions adjacent to each other in a plurality of target regions, the target regions adjacent to each other are merged into a single target region, to use the merged resulting target region and the remaining target regions of the plurality of target regions other than the merged target region as target regions for recognition.

At step S230, the image recognition module 130 may recognize a target object based on the target regions for recognition.

The order of the above steps is not limited, for example, step S210-3 may be performed in parallel with or may be performed before step S210-2. Another example is that step S220-1 may be performed in parallel with or may be performed before step S210.

Alternatively, the image recognition module 130 may include a pre-processing unit (such as a pre-processing unit 130-2 shown in FIG. 3A below) and a recognition unit (such as a recognition unit 130-1 shown in FIG. 3A below). The pre-processing unit may extract the target region in the original image where the target object is located based on the positioning information, and the recognition unit may recognize the target object based on the extracted target region.

FIGS. 3A to 3C are schematic diagrams illustrating an example of efficient recognition of a target object according to at least one example embodiment.

As shown in FIG. 3A and FIG. 3B, when recognition of the target object is started, the information acquisition module 120 may acquire positioning information of the target object, e.g., a distance, an elevation angle, an azimuth angle, etc. The information acquisition module 120 may also acquire inherent information of the target object, e.g., a color, a shape, an object size, etc. of the target object. The inherent information of the target object may be set or entered by a user. Here, for example, if the inherent information of the target object input by the user is a feature of a specific “key fob”, a positioning module corresponding to the positioning module of the recognition system 100 may be installed in the key fob to acquire positioning information of the key fob. The information acquisition module 120 may acquire the positioning information and the inherent information of the target object at the same time, or the inherent information of the target object may be acquired from the information acquisition module 120 while, after, and/or before the recognition unit acquires an extracted target region from the pre-processing unit 130-2.

When the recognition of the target object is started, the image acquisition module 110 may acquire an original image of the target object. The operation of the image acquisition module 110 to acquire the original image of the target object may be performed before, after, and/or simultaneously with the operation of the information acquisition module 120 to acquire the positioning information of the target object.

The pre-processing unit 130-2 may extract the target region in the original image where the target object is located based on the positioning information and the original image of the target object respectively from the information acquisition module 120 and the image acquisition module 110.

The recognition unit 130-1 may identify feature information of the target object based on the extracted target region and recognize the target object by comparing the inherent information of the target object with the identified feature information. In at least one example embodiment, the recognition unit 130-1 may include a machine learning module trained to classify objects and/or to identify the target object. The machine learning module, may, for example, use various artificial neural network organizations and processing models, the artificial neural network organizations including, for example, a convolutional neural network (CNN), a deconvolutional neural network, a recurrent neural network optionally including a long short-term memory (LSTM) and/or a gated recurrent unit (GRU), a stacked neural network (SNN), a state-space dynamic neural network (SSDNN), a deep belief network (DBN), a generative adversarial network (GAN), and/or a restricted Boltzmann machine (RBM), and/or the like; and/or include linear and/or logistic regression, statistical clustering, Bayesian classification, decision trees, and/or the like. For example, the identified feature information may include a type of the target object, a size, and/or a position of the target object in the original image. For example, the recognition unit 130-1 may recognize the type of the target object in the extracted target region and recognize the target object by comparing the inherent information (e.g., type) of the target object from the information acquisition module 120 with the identified type of the target object.

For example, as shown in FIG. 3C, with the target object at a distance of 8 meters (m) from the above installed image capture device, the right graph of FIG. 3C is a graph of a result obtained by only using a conventional image recognition technique without using the recognition system 100 according to the at least one example embodiment. At the distance of 8 m, the method of the right graph fails to recognize the key fob. Rather, the farthest recognition distance of the method of the right graph is 2.5 m and the recognition rate is 111 milliseconds (ms). In at least one embodiment, the recognition of the target object provides additional security by confirming both an identifier (e.g., an RFID) and the object. For example, the recognition of the target may provide additional security against identity skimmers copying digital identifiers. Additionally, in at least one embodiment, the recognition of the target object may be applied in, e.g., inventory retrieval systems, such as repositories including, e.g., inventory with digital identifiers. As such, a target stored in the inventory may be identified at a greater distance (e.g., at a distance of at least 8 m) and at greater speed compared to the comparative method illustrated in the right graph (e.g., at a distance of 2.5 m or less), thereby allowing for faster retrieval of the target object from the inventory.

The left graph of FIG. 3C is a graph of a result obtained by using the recognition system 100 according to the at least one example embodiment. The dashed box in the left graph is the extracted target region (the dashed box may or may not be shown in the obtained graph of the result) and the solid box is the recognized object, and the key fob is recognized. The method of the left graph may have a maximum recognition distance of up to 8.3 m and a recognition rate of 83 ms. It may be seen that extracting the target region from the original image to recognize the target object based on the inherent information of the target object by using the recognition system 100 according to the at least one example embodiment may lead to a significant increase in both the recognition distance and the recognition rate. For example, in at least one embodiment, the recognition system 100 can improve the efficiency of the processing resources by excluding objects outside of the target object, thereby allowing for those processing resources that would otherwise be directed towards the excluded objects to be applied to the target region.

FIG. 4 is a schematic diagram showing an example of accurate recognition of a target object according to at least one example embodiment.

FIG. 4 also shows an example of recognizing a specific key fob as described above, and the operations of the information acquisition module 120, the image acquisition module 110, the pre-processing unit 130-2, and the recognition unit 130-1 in FIGS. 3A and 3B are performed.

As shown in FIG. 4, the right graph of FIG. 4 is a graph of a result obtained by only using a conventional image recognition technique without using the recognition system 100 according to the at least one example embodiment. Four objects are recognized, but the result does not determine which object is a target object.

The left graph of FIG. 4 is a graph of a result obtained by using the recognition system 100 according to the at least one example embodiment. The dashed box is an extracted target region and the solid box is a recognized target object. The recognition unit may filter out an interference object (earphone) from the extracted target region by comparing the inherent information (color, shape, type, etc.) of the target object, and finally recognize the target object as a key fob.

FIGS. 5A to 5C are schematic diagrams illustrating another example of accurate recognition of a target object according to at least one example embodiment.

The operations of an information acquisition module 120, an image acquisition module 110 and a pre-processing unit 131-2 in FIGS. 5A and 5B are similar to the operations of the information acquisition module 120, the image acquisition module 110 and the pre-processing unit 130-2 in FIGS. 3A and 3B, and are therefore not repeated here. FIGS. 5A to 5C also take the example of recognizing a specific key fob as described above.

According to at least one example embodiment, the recognition unit 131-1 may identify feature information of a target object (e.g., position, size and type of the target object in the image, etc.) based on an extracted target region from the preprocessing unit and recognize the target object by comparing the feature information with a feature of the target region extracted based on the positioning information. Specifically, the recognition unit 131-1 is configured to recognize the target object by comparing at least one of the size and the position of the target object in the original image correspondingly with at least one of the size and the position of the extracted target region.

For example, as shown in FIG. 5C, with the target object at a distance of 2 m from the above installed image capture device, the right graph of FIG. 5C is a graph of a result obtained by only using a conventional image recognition technique without using the recognition system 100 according to the at least one example embodiment. Four objects may be recognized, the result does not determine which object is the target object.

The left graph of FIG. 5C is a graph of a result obtained by using the recognition system 100 according to the at least one example embodiment. The dashed box is an extracted target region. Based on this target region, the recognition unit may recognize two objects in the solid box (e.g., feature information of the two objects, including position, size, type, etc.), which are a key fob and an earphone (the two solid boxes shown in the figure are only used to make it easy for those skill in the art to understand, and do not represent finally recognized objects). The recognition unit may further recognize the target object by comparing the sizes of the objects in the feature information with the size of the target region extracted based on the positioning information. For example, the recognition unit may find that the size of the recognized key fob is consistent with the size of the target region, while the size of the earphone is significantly different from the size of the target region, so the key fob may be determined as the target object. Alternatively, after the recognition unit recognizes the above two objects, the recognition unit may further recognize the target object by comparing the positions of the objects in the feature information (for example, the coordinates of the center point of the solid box) with the position of the extracted target region (for example, the coordinates of the center point of the dashed box).

Alternatively, in order to improve the recognition accuracy, the recognition unit may recognize the target object by comparing the positions, the sizes, and the types of the objects in the identified feature information correspondingly with the position, the size, and the type of the target region.

FIG. 6 is a diagram showing an example of accurate recognition of a plurality of target objects according to at least one example embodiment.

As shown in FIG. 6, taking recognition of four target objects (A, B, C, and D) as an example, the operations of the information acquisition module 120, the image acquisition module 110, the preprocessing unit 131-2 and the recognition unit 131-1 in FIG. 5A and FIG. 5B may be performed.

According to the at least one example embodiment, the information acquisition module 120 may acquire positioning information of a plurality of target objects (A, B, C, and D) in an original image. After step \textcircled{1}, the image recognition module 130 may extract a plurality of target regions in the original image where the plurality of target objects are located based on the plurality of positioning information of the plurality of target objects. After step \textcircled{2}, the image recognition module 130 may merge target regions adjacent to each other in the plurality of target regions into one target region, so as to use the merged target region and the other target regions in the plurality of target regions except the merged target region as target regions for recognition, and after step \textcircled{3}, plurality of target objects are recognized based on the target regions for recognition. For example, the image recognition module 130 may identify plurality of feature information of the plurality of target objects based on the target regions for recognition, and after step \textcircled{4}, the plurality of target objects are recognized by comparing the plurality of feature information with features of the plurality of target regions extracted based on the plurality of positioning information.

For example, the thin dotted box in FIG. 6 is the extracted target regions, the thick dotted box is the target regions for recognition, and the solid box is the recognized objects. In addition, the image recognition module 130 may recognize the target regions for recognition in parallel or in sequence (such as the two thick dotted boxes in FIG. 6).

As an example only, the image recognition module 130 may recognize target objects A, B, C, and D by comparing positions of objects in identified feature information with positions of extracted target regions. For example, after step \textcircled{3} in FIG. 6, in the upper thick dotted box in FIG. 6, the image recognition module 130 recognizes three objects in three solid boxes in the upper thick dotted box and another object (not shown) in another solid box in the upper thick dotted box, at this time, the image recognition module 130 may further compare feature information (for example, position) of these objects with the extracted target regions (for example, position). If the image recognition module 130 finds that the position of the other object does not match the position of the extracted target region, it is determined that the other object is not the target object.

As an example only, when the image recognition module recognizes four objects after step \textcircled{3} in FIG. 6, the image recognition module may add corresponding identifiers to the four objects. For example, the image recognition module may recognize two of the four objects as earphones and the other two as key fobs, and add different identifiers to the earphones and key fobs respectively to distinguish the earphones and the key fobs. The above identifiers may be included in the object information correspondingly. When the user needs to be provided with the type of the recognized target object, the type of the target object may be displayed in the vicinity of the recognized target object according to the identifier.

According to at least one example embodiment, after a target object is identified, related information of the recognized target object (e.g., the type of the target object) may be displayed in a display. In addition, related control operations (e.g., security control operations) can be performed based on the related information of the recognized target object. For example, if the recognized target object is a specific type of target object, the user is allowed to access a related device, otherwise, the user is denied access to the related device. Optionally, the related information of the recognized target object can be sent to the server, so that the server can perform related control operations based on it. It should be noted that subsequent operations for which the recognized target object can be used are not limited to the above examples.

FIG. 7 is a flowchart showing a recognition method according to at least one example embodiment.

In step S710, the information acquisition module 120 may acquire positioning information of a target object.

In step S720, the image acquisition module 110 may acquire an original image of the target object.

In step S730, the image recognition module 130 may extract a target region in the original image where the target object is located based on the positioning information, and recognize the target object based on the extracted target region. In addition, the image recognition module may identify feature information of the target object based on the extracted target region, and recognize the target object by comparing inherent information of the target object from the information acquisition module 120 with the feature information of the target object. In addition, the image recognition module may recognize the feature information of the target object based on the extracted target region, and recognize the target object by comparing the feature information of the target object with a feature of the target region extracted based on the positioning information.

As will be appreciated by one skilled in the art, the example embodiments in this disclosure may be embodied as a system, method, computer program product, and/or a computer program product embodied in one or more computer readable medium(s) having computer readable program code embodied thereon. The computer readable program code may be provided to a processor of a general purpose computer, special purpose computer, and/or other programmable data processing apparatus. The computer readable medium may be a computer readable signal medium and/or a computer readable storage medium. The computer readable storage medium may be any tangible medium that can contain, and/or store a program for use by or in connection with an instruction execution system, apparatus, or device.

For example, the functional blocks denoting elements that process (and/or perform) at least one function or operation and may be included in and/or implemented as processing circuitry such hardware, software, or the combination of hardware and software. For example, the processing circuitry more specifically may include (and/or be included in), but is not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, application-specific integrated circuit (ASIC), semiconductor elements in an integrated circuit, circuits enrolled as an intellectual property (IP), etc.

For example, the term “module” may refer to a software component and/or a hardware component such as a field programmable gate array (FPGA) or an application specific integrated circuit (ASIC), and/or combination of a hardware component and a software component. However, a “module” is not limited to software or hardware. A “module” may be configured to be included in an addressable storage medium or to reproduce one or more processors. Accordingly, for example, a “module” may include components such as software components, object-oriented software components, class components, and task components, processes, functions, attributes, procedures, subroutines, segments of program code, drivers, firmware, microcode, circuits, data, databases, data structures, tables, arrays, and variables. In addition, the above modules or units may be integrated into fewer modules or units, or may be divided into more modules or units to achieve the same functions.

According to at least one embodiment of the present disclosure, a computer readable storage medium storing a computer program is also provided. The computer program, when executed by at least one processor, causes the at least one processor to perform any of the above methods according to the exemplary embodiments of the present disclosure. Examples of computer-readable storage media herein include: Read Only Memory (ROM), Random Access Programmable Read Only Memory (RAPROM), Electrically Erasable Programmable Read Only Memory (EEPROM), Random Access Memory (RAM), Dynamic Random Access Memory (DRAM), Static Random Access Memory (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, Blue-ray or optical disk storage, Hard Disk Drive (HDD), Solid State Drive (SSD), card storage (such as multimedia cards, secure digital (SD) cards or extremely fast digital (XD) cards), magnetic tapes, floppy disks, magneto-optical data storage devices, optical data storage devices, hard disks, solid state disks, and any other devices that are configured to store computer programs and any associated data, data files and data structures in a non-transitory manner and provide the computer programs and any associated data, data files and data structures to a processor or computer so that the processor or computer can execute the computer programs. The instructions or computer programs in the computer-readable storage medium described above may be executed in an environment deployed in a computer device. In addition, in one example, the computer programs and any associated data, data files, and data structures are distributed on a networked computer system, so that the computer programs and any associated data, data files, and data structures are stored, accessed, and executed through one or more processors or computers in a distributed manner.

According to the example embodiments of the present disclosure, the positioning information of the target object is acquired by using the location technology, the target region is dynamically extracted from the original image, and the invalid interference object is removed, so that the image down-sampling rate may be kept in a small range, thereby ensuring that the features of the target object to be recognized are not compressed. At the same time, the size of the region to be recognized is reduced, and the running speed of the image recognition neural network is improved. In these ways, small object information may appear in the deeper feature network, thus improving the recognition speed and accuracy.

After considering the specification and the practice of the invention disclosed herein, those skilled in the art will readily conceive of other implementations of the present disclosure. This application is intended to cover any variation, use or adaptation of the present disclosure that follows the general principles of the present disclosure and includes the common knowledge or customary technical means in the field of technology not disclosed by the present disclosure. The specification and embodiments are deemed to be exemplary only, and the true scope and spirit of the present disclosure are indicated by the claims below.

It should be understood that the present disclosure is not limited to the precise structure already described above and shown in the attached drawings and is subject to various modifications and changes within its scope. The scope of the present disclosure is limited only by the attached claims.

What is claimed is:

1. A recognition system, comprising:
processing circuitry configured to
acquire an original image of a target object;
acquire positioning information of the target object, the positioning information of the target object including information about the target object's position in physical space;
extract a target region in the original image based on the positioning information; and
recognize the target object based on the extracted target region.

2. The recognition system according to claim 1, wherein the processing circuitry is further configured to
acquire information about the target object, and
wherein the recognize the target object includes
identifying feature information of the target object based on the extracted target region, and
recognizing the target object by comparing the information about the target object with the feature information.

3. The recognition system according to claim 1, wherein the recognize the target object includes
identifying feature information of the target object based on the extracted target region, and
recognizing the target object by comparing the feature information with a feature of the target region extracted based on the positioning information.

4. The recognition system according to claim 3, wherein
the feature information comprises at least one of a size and a location of the target object in the original image,
the feature of the extracted target region comprises at least one of a size and a location of the extracted target region, and
the recognize the target object includes comparing at least one of the size and the position of the target object in the original image with the corresponding at least one of the size and the position of the extracted target region.

5. The recognition system according to claim 1, wherein the extract the target region includes
determining, based on the positioning information, a position and a size of the target region in the original image, and
extracting the target region based on the position and the size of the target region.

6. The recognition system according to claim 1, wherein the processing circuitry is further configured to
determine whether there is a plurality of target objects in the original image;
extract a plurality of target regions in the original image based on a plurality of positioning information of the plurality of target objects respectively based on a determination that there is the plurality of target objects, the plurality of target regions including at least one corresponding target object of the plurality of target objects,
merge adjacent target regions, of the plurality of target regions, into a merged target region,
use the merged target region and a remainder of the plurality of target regions as target regions for recognition, and
recognize at least one of the plurality of target objects based on the target regions for recognition.

7. The recognition system according to claim 6, wherein the recognize the at least one of the plurality of target objects includes
identifying a plurality of feature information of the plurality of target objects based on the target regions for recognition, and
recognizing the at least one of the plurality of target objects by comparing the plurality of feature information with features of the plurality of target regions extracted based on the plurality of positioning information.

8. The recognition system of claim 1, wherein the acquire positioning information includes communicating with the target object using radio identification technology.

9. The recognition system of claim 8, wherein the radio identification technology includes at least one of radio-frequency identification (RFID), Bluetooth technology, ultra-wideband (UWB) technology, or wireless fidelity (WiFi) technology.

10. The recognition system of claim 1, wherein
the acquire the original image includes using an image capture device, and
the acquire positioning information includes acquiring information regarding at least one of a distance, an elevation, or an azimuth angle of the target object in relation the image capture device.

11. A recognition method, comprising:
acquiring an original image of a target object;
acquiring positioning information of the target object, the positioning information of the target object including information about the target object's position in physical space; and
extracting a target region in the original image based on the positioning information; and
recognizing the target object based on the extracted target region.

12. The recognition method according to claim 11, further comprising:
acquiring information about the target object, and
wherein the recognizing of the target object comprises
identifying feature information of the target object based on the extracted target region, and
recognizing the target object by comparing the information about the target object with the feature information.

13. The recognition method according to claim 11, wherein the recognizing of the target object comprises
identifying feature information of the target object based on the extracted target region, and
recognizing the target object by comparing the feature information with a feature of the target region extracted based on the positioning information.

14. The recognition method according to claim 13, wherein the feature information comprises at least one of a size and a location of the target object in the original image,
the feature of the extracted target region comprises at least one of a size and a location of the extracted target region, and
the recognizing of the target object comprises comparing at least one of the size and the position of the target object in the original image with the corresponding at least one of the size and the position of the extracted target region.

15. The recognition method according to claim 11, wherein the extracting of the target region comprises
determining based on the positioning information, a position and a size of the target region in the original image, and
extracting the target region based on the position and the size of the target region.

16. The recognition method according to claim 11 further comprises:
determining whether there is a plurality of target objects in the original image;
extracting a plurality of target regions in the original image, based on a plurality of positioning information of the plurality of target objects respectively based on a determination that there is the plurality of target objects, the plurality of target regions including at least one corresponding target object of the plurality of target objects;
merging adjacent target regions of the plurality of target regions into a single target region;
using the merged target region and a remainder of the plurality of target regions as target regions for recognition; and
recognizing at least one of the plurality of target objects based on the target regions for recognition.

17. The recognition method according to claim 16, wherein the recognizing of the at least one of the plurality of target objects comprises:
identifying a plurality of feature information of the plurality of target objects based on the target regions for recognition, and
recognizing the at least one of the plurality of target objects by comparing the plurality of feature information with features of the plurality of target regions extracted based on the plurality of positioning information.

18. A computer readable storage medium, wherein the computer readable storage medium stores computer program instructions thereon, the computer program instructions, when executed by a processor, cause the processor to implement the method of claim 11.
